(19) United States
(12) Patent Application Publication
(10) Pub. No.: US 2025/0164298 A1
(43) Pub. Date: May 22, 2025

(54) FLOW RATE MEASUREMENT MECHANISM AND FLUID CONTROL APPARATUS

(71) Applicant: HORIBA STEC, Co., Ltd., Kyoto-shi (JP)

(72) Inventors: Edward COCCIADIFERRO, Irvine, CA (US); John DICK, Irvine, CA (US)

(21) Appl. No.: 18/948,860

(22) Filed: Nov. 15, 2024

(30) Foreign Application Priority Data
Nov. 21, 2023 (JP) 2023-197175

(51) Int. Cl. G01F 1/38; G01F 1/40

(52) U.S. Cl. CPC G01F 1/383; G01F 1/40

(57) ABSTRACT

A fluid resistance element is disposed on a flow path along which flows a fluid, and in which a resistance flow path is formed. A fluid receiving portion is provided on the flow path and is hit by the fluid flowing from upstream of the fluid resistance element so as to cause the fluid to flow to a side. Flexible components support the fluid resistance element and deform in accordance with a flow rate of the fluid. A displacement sensor measures a displacement of the flexible components, and a flow rate calculation unit calculates a flow rate of the fluid based on the displacement. The fluid that is made to flow to the side by the fluid receiving portion flows along the resistance flow path of the fluid resistance element.

### CROSS-REFERENCE TO RELATED APPLICATION

The present application claims priority to Japanese Patent Application No. 2023- 197175 filed Nov. 21, 2023, entitled “FLOW RATE MEASUREMENT MECHANISM AND FLUID CONTROL APPARATUS” which is incorporated herein by reference in its entirety.

### BACKGROUND OF THE INVENTION

### Technical Field

The present invention relates to a flow rate measurement mechanism, and to a fluid control apparatus.

### Description of the Related Art

Conventionally, a pressure-based flow rate sensor is used as a flow rate sensor of a fluid control apparatus (commonly known as a mass flow controller). This pressure-based flow rate sensor includes an upstream-side pressure sensor that measures a pressure on an upstream side of a fluid resistance element on a flow path, and a downstream-side pressure sensor that measures a pressure on a downstream side of the fluid resistance element, and measures a flow rate based on the upstream-side pressure and the downstream-side pressure measured by these pressure sensors.

However, in order to measure a flow rate, it is necessary for two sensors, namely, an upstream-side pressure sensor and a downstream-side pressure sensor to be provided, and in order to measure a flow rate with a high degree of accuracy, pressure sensors having a high degree of accuracy are required and this fact causes costs to increase.

On the other hand, as is shown in Patent Document 2, it is also possible to consider a structure in which a flow rate is calculated without using pressure sensors by measuring a displacement of a diaphragm that is provided on a rectilinear flow path. More specifically, the flow rate may be calculated by forming an aperture in a diaphragm through which a fluid is able to travel.

However, in the above-described structure, because a structure is employed in which an aperture is formed facing in the direction of a rectilinear flow path, and portions other than this aperture are affected by pressure from a fluid so as to become deformed, the surface area that receives pressure from the fluid is limited by the aperture. As a result, the amount of deformation of the diaphragm that is caused by changes in the flow rate is reduced, and it becomes difficult to accurately determine a flow rate from an amount of deformation of a diaphragm.

### DOCUMENTS OF THE PRIOR ART

### Patent Documents

Patent Document 1: Japanese Unexamined Patent Application Publication No. 2016-102807
Patent Document 2: Japanese Patent No. 6545377

### SUMMARY OF THE INVENTION

The present invention was therefore conceived in order to solve the above-described problems, and it is an object thereof to enable highly accurate flow rate measurements to be made at the same time as costs are reduced.

In other words, a flow rate measurement mechanism according to the present invention is provided with a fluid resistance element that is provided on a flow path along which flows a fluid, and in which a resistance flow path is formed, a fluid receiving portion that is provided on the flow path and is hit by the fluid flowing from an upstream side of the fluid resistance element so as to cause the fluid to flow to a side, a flexible component that supports the fluid resistance element and deforms in accordance with a flow rate of the fluid, a displacement sensor that measures a displacement of the flexible component, and a flow rate calculation unit that calculates a flow rate of the fluid based on the displacement measured by the displacement sensor, and is characterized in that a structure is employed in which the fluid that is made to flow to a side by the fluid receiving portion flows along the resistance flow path of the fluid resistance element.

According to this flow rate measurement mechanism, because it is not necessary to provide two pressure sensors, namely, an upstream-side pressure sensor and a downstream-side pressure sensor, as is the case in a conventional structure, it is possible to reduce the cost of a flow rate measurement mechanism. Moreover, because a structure is employed in which a fluid flowing from an upstream side of a fluid resistance element hits against a fluid receiving portion, and thereafter the fluid flowing to a side flows along a resistance flow path of the fluid resistance element, it is possible to enlarge a surface area that receives pressure from the fluid flowing through the flow path, and to increase an amount of deformation of a diaphragm that is based on a change in the flow rate. As a result, in a case in which displacement of a flexible component is measured and the flow rate of a fluid is calculated based on this displacement, it is possible to perform a highly accurate flow rate measurement.

A specific embodiment of a fluid resistance element that may be considered is a structure in which the fluid resistance element is formed by a laminated body, and the resistance flow path is formed in a direction that intersects the direction of lamination. In this case, it is desirable that the flexible component support an upstream-side portion of the fluid resistance element.

A specific embodiment of a fluid resistance element that may be considered is a structure in which, when viewed from the direction of lamination, a fluid intake portion where a starting end of the resistance flow path opens up is formed in a central portion of the fluid resistance element, and the resistance flow path extends towards an outer peripheral portion from the fluid intake portion. In this structure, it is desirable that the fluid receiving portion be disposed so as to face the fluid intake portion on a downstream side of the central portion of the fluid resistance element. If this type of structure is employed, then it becomes possible to increase the surface area that receives pressure from the fluid flowing through the flow path, and to increase the amount of deformation of the diaphragm that is caused by changes in the flow rate.

It is also desirable that the flexible component include an upstream-side flexible component and a downstream-side flexible component that support the fluid resistance element by sandwiching it from both sides, and that no through holes be formed in the downstream-side flexible component so that the fluid flows out from between the upstream-side flexible component and the downstream-side flexible component. In addition, it is also desirable that through holes that enable the fluid to flow into the fluid resistance element be formed in the upstream-side flexible component, and that fluid that has passed through the fluid resistance element flow out from between the upstream-side flexible component and the downstream-side flexible component.

Moreover, in a case in which the downstream-side flexible component out of the above-described pair of flexible components is formed in a flat plate shape, then it is possible for the amount of displacement of this downstream-side flexible component to be increased. In this structure, it is desirable that the displacement sensor measure the displacement of the downstream- side flexible component out of the above-described pair of flexible components.

In a case in which the fluid resistance element is sandwiched by a pair of flexible components, a space is formed on an outer side of the fluid resistance element between the upstream-side flexible component and the downstream-side flexible component. In order to achieve a reduction in the size of the flow rate measurement mechanism by effectively utilizing this space, it is desirable that the displacement sensor be disposed on the outer side of the fluid resistance element between the upstream-side flexible component and the downstream-side flexible component.

It is desirable that the flow rate measurement mechanism of the present invention be further provided with an annular spacer component that is disposed so as to surround a periphery of the fluid resistance element between the upstream-side flexible component and the downstream- side flexible component. If this type of structure is employed, then it is a simple matter to fix the pair of flexible components on both sides of the fluid resistance element to a flow path block. In other words, it is sufficient for the pair of flexible components to be gripped by the flow path block via the spacer component. In this structure, in order to enable the fluid that has passed through the fluid resistance element to flow out to the outside of the pair of flexible components, it is desirable that an outflow path through which the fluid that has passed through the fluid resistance element flows be formed in the spacer component.

It is also desirable that the flow rate measurement mechanism of the present invention be further provided with a magnetic force adjustment mechanism that employs magnetic force to adjust the displacement of the flexible component or the fluid resistance element, and that the flow rate calculation unit calculate a flow rate of the fluid based on the displacement measured by the displacement sensor and on the magnetic force employed by the magnetic force adjustment mechanism.

If this type of structure is employed, then because it is possible to adjust the displacement of the flexible component or the fluid resistance element in accordance with the flow rate of the fluid using magnetic force, the flow rate measurement range or the flow rate measurement sensitivity can be adjusted dynamically. In other words, by employing a combination of the deformation by the flexible component with magnetic force, it is possible for the flow rate calculated by the flow rate calculation unit to be made a variable flow rate. For example, in a case in which a user wishes to widen the flow rate measurement range, increasing the magnetic force employed by the magnetic force adjustment mechanism so as to make it more difficult for the flexible component to be deformed in accordance with the flow rate may be considered. Moreover, in a case in which a user wishes to heighten the flow rate measurement sensitivity, reducing or terminating the magnetic force employed by the magnetic force adjustment mechanism so as to make it easier for the flexible component to be deformed in accordance with the flow rate may be considered.

Furthermore, a flow rate measurement mechanism according to the present invention is characterized in being provided with a fluid resistance element that is disposed on a flow path along which flows a fluid, and in which a resistance flow path is formed, a flexible component that supports the fluid resistance element and deforms in accordance with a flow rate of the fluid, a displacement sensor that measures a displacement of the flexible component or the fluid resistance element, a magnetic force adjustment mechanism that employs magnetic force to adjust the displacement of the flexible component or the fluid resistance element, and a flow rate calculation unit that calculates a flow rate of the fluid based on the displacement measured by the displacement sensor.

If this type of flow rate measurement mechanism is employed, then because it is possible to adjust the displacement of the flexible component or fluid resistance element in accordance with the flow rate of the fluid by using magnetic force, the flow rate measurement range or the flow rate measurement sensitivity can be adjusted dynamically. In other words, by employing a combination of the deformation by the flexible component with magnetic force, it is possible for the flow rate calculated by the flow rate calculation unit to be made a variable flow rate. For example, in a case in which a user wishes to widen the flow rate measurement range, increasing the magnetic force employed by the magnetic force adjustment mechanism so as to make it more difficult for the flexible component to be deformed in accordance with the flow rate may be considered. Moreover, in a case in which a user wishes to heighten the flow rate measurement sensitivity, reducing or terminating the magnetic force employed by the magnetic force adjustment mechanism so as to make it easier for the flexible component to be deformed in accordance with the flow rate may be considered.

As a specific aspect of the present invention, it is desirable that a magnet on which magnetic force acts be provided in the flexible component or the fluid resistance element, and that the magnetic force adjustment mechanism include an electromagnetic coil that generates the magnetic force.

If this type of structure is employed, then by controlling the current supplied to the electromagnetic coil, it is possible to adjust the displacement of the flexible component or fluid resistance element by using magnetic force. Moreover, by supplying high current pulses to the electromagnetic coil, the fluid resistance element can be rapidly restored to its original position.

As a specific aspect of the present invention, it is desirable that the flow rate calculation unit calculate a flow rate of the fluid based on the displacement measured by the displacement sensor and on the magnetic force employed by the magnetic force adjustment mechanism.

It is also desirable that the flow rate measurement mechanism according to the present invention be further provided with a pressure sensor that is disposed on the flow path on the upstream side of the fluid resistance element, and with a temperature sensor that measures a temperature of a fluid flowing through the flow path. In this structure, it is desirable that the flow rate calculation unit calculate a flow rate of the fluid based on the displacement measured by the displacement sensor, the pressure measured by the pressure sensor, and the temperature measured by the temperature sensor. More specifically, it is desirable that the flow rate calculation unit perform a density correction on the fluid using the pressure measured by the pressure sensor, and then calculate the flow rate of the fluid.

Moreover, a fluid control apparatus according to the present invention is characterized in being provided with the above-described flow rate measurement mechanism, and with a fluid control valve that is disposed on the upstream side or the downstream side of the flow rate measurement mechanism.

According to the present invention, it is possible, in the manner described above, to enable highly accurate flow rate measurements to be made at the same time as costs are reduced.

### BRIEF DESCRIPTION OF THE DRAWINGS

FIG. 1 is a view schematically showing a structure of a fluid control apparatus according to an embodiment of the present invention;

FIG. 2 is a cross-sectional view schematically showing a structure of a flow rate measurement mechanism (prior to a deformation of a flexible component) of the same embodiment;

FIG. 3 is a cross-sectional view schematically showing a structure of a flow rate measurement mechanism (subsequent to a deformation of a flexible component) of the same embodiment;

FIG. 4 is a cross-sectional view schematically showing a structure of a flow rate measurement mechanism of a variant embodiment;

FIG. 5 is a cross-sectional view schematically showing a structure of a flow rate measurement mechanism of a variant embodiment; and

FIG. 6 is a cross-sectional view schematically showing a structure of a flow rate measurement mechanism (subsequent to a deformation of a flexible component) of a variant embodiment.

### DETAILED DESCRIPTION

Hereinafter, an embodiment of a fluid control apparatus according to the present invention will be described with reference made to the drawings. Note that, in order to simplify an understanding thereof, each of the drawings depicted below is shown schematically with omissions or enhancements made where these have been deemed appropriate. In addition, component elements that are the same in the respective drawings are indicated by the same descriptive symbols and any duplicated description thereof is omitted.

### Structure of a Fluid Control Apparatus

A fluid control apparatus 100 of the present embodiment is used, for example, in a semiconductor manufacturing process, and is provided on either one or a plurality of gas supply lines so as to control a flow rate of processing gas that is flowing through each gas supply line.

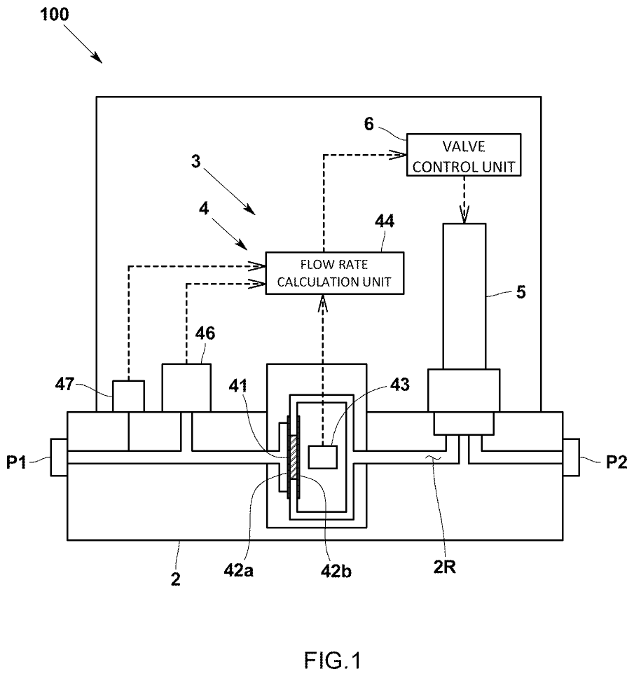

More specifically, as is shown in FIG. 1, the fluid control apparatus 100 is provided with a flow path block 2 in which is formed an internal flow path 2R, and with a fluid control device 3 that is mounted on the flow path block 2.

The flow path block 2 is provided with an intake port Pl through which a fluid is introduced into the internal flow path 2R, and with a discharge port P2 through which a fluid is discharged from the internal flow path 2R. An upstream-side pipe (not shown in the drawings) is connected to the intake port P1, while a downstream-side pipe P2 (not shown in the drawings) is connected to the discharge port P2.

The fluid control device 3 controls a fluid inside the internal flow path 2R, and includes a flow rate measurement mechanism 4 that measures a flow rate of the fluid flowing through the internal flow path 2R, a fluid control valve 5 that is disposed on either an upstream side or a downstream side (shown on the downstream side in FIG. 1) of the fluid control mechanism 4, and a valve control unit 6 that performs feedback control on a valve aperture of the fluid control valve 5 based on a deviation between a measurement flow rate obtained by the flow rate measurement mechanism 4 and a set flow rate.

The fluid control valve 5 controls the flow rate by causing a valve body to move forwards or backwards relative to a valve seat by means of an actuator such as, for example, a piezo actuator or the like.

The valve control unit 6 is what is commonly known as a computer that is equipped, for example, with a CPU, memory, A/D and D/A converters, and input/output devices. This computer performs the functions of the valve control unit 6 as a result of a fluid control program stored in the memory being executed so as to cause the various devices to operate in mutual collaboration with each other.

### Specific Structure of the Flow Rate Measurement Mechanism 4

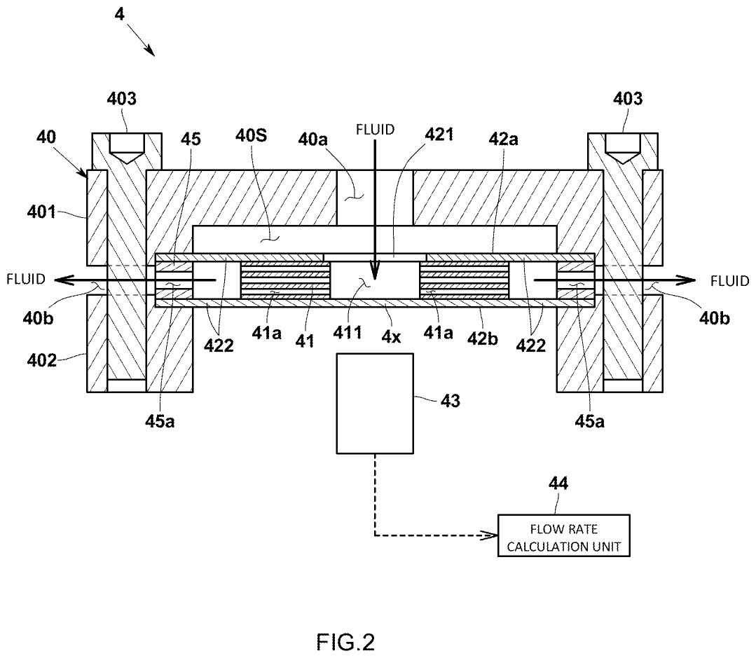

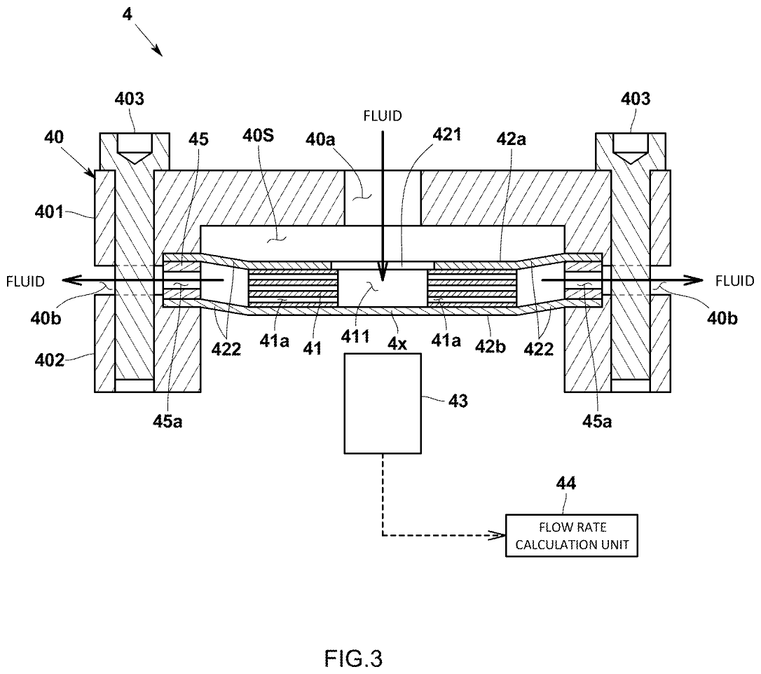

Next, the structure of the flow rate measurement mechanism 4 of the present embodiment will be described in detail with reference to FIG. 2 and FIG. 3.

More specifically, as is shown in FIG. 2 and FIG. 3, the flow rate measurement mechanism 4 is provided with a fluid resistance element 41, a fluid receiving portion 4x, flexible components 42a and 42b that support the fluid resistance element 41 by sandwiching it from both sides and that deform correspondingly to the flow rate of the fluid, a displacement sensor 43 that measures a displacement of the flexible components 42a and 42b, and a flow rate calculation unit 44 that calculates a flow rate of the fluid based on the displacement measured by the displacement sensor 43.

In the flow rate measurement mechanism 4 of the present embodiment, the fluid resistance clement 41, the fluid receiving portion 4x, the flexible components 42a and 42b, and the displacement sensor 43 are each provided in a measurement block 40 in which is formed a measurement space 40S. This measurement space 40S that is formed in the measurement block 40 communicates with the internal flow path 2R. Here, an intake path 40a through which the fluid flowing through the internal flow path 2R is introduced into the measurement space 40S, and discharge paths 40b through which the fluid is guided back into the internal flow path 2R from the measurement space 40S are formed in the measurement block 40. Moreover, the intake path 40a and the discharge paths 40b are in a mutually intersecting positional relationship (for example, arc mutually orthogonal) relative to each other. Note that the intake path 40a is formed in a first block clement 401 of the measurement block 40 (described below). The discharge paths 40b are formed between the first block element 401 of the measurement block 40 (described below) and a second block element 402.

The fluid resistance clement 41 is provided in the measurement block 40, and a resistance flow path 41a that communicates with the measurement space 40S thereof is formed in the fluid resistance element 41. This fluid resistance clement 41 is disposed opposite an inflow port of the intake path 40a. The fluid resistance clement 41 of the present embodiment is a laminated body that is formed by stacking a plurality of thin plates on top of each other, and a plurality of the resistance flow paths 41a are formed within the fluid resistance element 41 so as to extend in a direction that intersects (for example, is orthogonal to) the direction in which the plurality of thin plates are stacked.

More specifically, schematically the fluid resistance clement 41 is formed substantially in the shape of a rotating body in which, when viewed from the direction of lamination, a fluid intake portion 411 in which starting ends of the resistance flow paths 41a open up is formed in a central portion thereof, and the resistance flow paths 41a extend from the fluid intake portion 411 towards outer peripheral portions. In other words, in the fluid resistance element 41 of the present embodiment, terminating ends of the resistance flow paths 41a open in an outer side peripheral surface thereof and the fluid flows out from this outer side peripheral surface. Namely, the fluid resistance element 41 alters the flow direction (here, the intake direction of the intake path 40a) of the fluid introduced from the intake path 40a to an intersecting direction (here, the discharge direction of the discharge paths 40b) and then allows this fluid to flow out.

The flexible components 42a and 42b include an upstream-side flexible component 42a and a downstream-side flexible component 42b that support the fluid resistance clement 41 in the measurement block 40 by sandwiching it from both sides. The pair of flexible components 42a and 42b are disposed opposite the inflow port of the intake path 40a. Moreover, the pair of flexible components 42a and 42b deform correspondingly to the flow rate of the fluid flowing in from the intake path 40a in the measurement block 40. The pair of flexible components 42a and 42b arc formed by thin metal plates (i.e., diaphragms).

The pair of flexible components 42a and 42b support the fluid resistance element 41 in the direction of lamination by sandwiching it from both sides. In addition, of the pair of flexible components 42a and 42b, the upstream-side flexible component 42a supports the upstream-side portion of the fluid resistance clement 41, and a through hole 421 that enables fluid to flow into the fluid resistance clement 41 is formed in the upstream-side flexible component 42a. This through hole 421 is formed so as to correspond to the fluid intake portion 411 of the fluid resistance clement 41, and communicates with the fluid intake portion 411. In addition, of the pair of flexible components 42a and 42b, the downstream-side flexible component 42b supports the downstream- side portion of the fluid resistance clement 41, and there is no through hole formed in a position therein that corresponds to the fluid resistance element 41.

In other words, a structure is employed in which the downstream-side flexible component 42b includes the fluid receiving portion 4x. This fluid receiving portion 4x is hit by fluid flowing from the upstream side of the fluid resistance clement 41 and causes this fluid to flow to the sides. More specifically, the fluid receiving portion 4x is disposed so as to face the fluid intake portion 411 on the downstream side of the central portion of the fluid resistance clement 41. In the fluid resistance clement 41 of the present embodiment, because the fluid intake portion 411 is provided so as to penetrate the central portion thereof, then because the flexible component 42b covers the terminating end of this penetration portion, the portion of the flexible component 42b that covers the penetration portion forms the fluid receiving portion 4x. In addition, in this structure, the fluid made to flow to the sides by the fluid receiving portion 4x flows through the resistance flow paths 41a of the fluid resistance clement 41.

Here, an annular spacer component 45 is provided between the pair of flexible components 42a and 42b so as to surround a periphery of the fluid resistance element 41. This spacer component 45 maintains the space between the pair of flexible components 42a and 42b that support the fluid resistance element 41 from both sides thereof at a uniform distance. In the present embodiment, the measurement block 40 includes the first block element 401 and the second block clement 402, and a structure is consequently created in which the pair of flexible components 42a and 42b are gripped by these block elements 401 and 402. Here, the pair of flexible components 42a and 42b are gripped using fixing screws 403. As a result of this, the spacer component 45 maintains the space between pair of flexible components 42a and 42b in a state in which the pair of flexible components 42a and 42b are gripped by the block elements 401 and 402.

Moreover, the spacer component 45 is disposed at a predetermined distance from the outer-side peripheral surface of the fluid resistance element 41. The spacer component of the present embodiment is formed in an annular shape, and is disposed so as to be concentric with the fluid resistance element 41. Here, in the pair of flexible components 42a and 42b, a portion between the spacer component 45 and a fluid resistance element 51 forms a deformation portion 422 which is the main portion that is deformed. In addition, an outflow path 45a through which passes the fluid that has traveled through the fluid resistance element 41 is formed in the spacer component 45.

In this type of structure, fluid that has flowed from the intake path 40a of the measurement block 40 to the measurement space 40S then flows into the fluid intake portion 411 of the fluid resistance element 41 via the through hole 421 in the upstream-side flexible component 42a. The fluid that has flowed into the fluid intake portion 411 then hits against the fluid receiving portion 4x and the direction in which this fluid is flowing is altered so that the fluid travels towards the sides of the resistance element 41 (here, towards an outer side in a radial direction). Next, the fluid flows through the resistance flow paths 41a in the fluid resistance element 41, and then flows out between the pair of flexible component 42a and 42b from the outer-side peripheral surface of the fluid resistance element 41. Here, the fluid flowing in from the intake path 40a hits against the pair of flexible components 42a and 42b and the fluid resistance element 41, and the pair of flexible components 42a and 42b are displaced so as to bend towards the opposite side from the intake path 40a. The fluid that has passed through the fluid resistance element 41 then travels through the outflow path 45a in the spacer component 45, and then flows between the pair of flexible components 42a and 42b to the outside. Thereafter, the fluid flows through the outflow path 40b in the measurement block 40 and flows into the internal flow path 2R.

The displacement sensor 43 measures the displacement of the pair of flexible components 42a and 42b. In the present embodiment, the displacement sensor 43 measures the displacement of the downstream-side flexible component 42b. More specifically, the displacement sensor 43 is disposed on the opposite side of the downstream-side flexible component 42b from the measurement space 40S (i.e., the intake path 40a). In other words, the displacement sensor 43 of the present embodiment is disposed outside the measurement space 40S. Sensors that may be used as the displacement sensor 43 include capacitive sensors, oil-filled pressure sensors, position sensors, magnetic sensors, and eddy current sensors and the like.

The flow rate calculation unit 44 calculates the flow rate of a fluid flowing through the internal flow path 2R (i.e., through the fluid resistance element 41) based on the displacement measured by the displacement sensor 43. More specifically, the flow rate calculation unit 44 calculates the flow rate from the displacement measured by the displacement sensor 43 using relational data that shows a relationship between the displacement measured by the displacement sensor 43 and the flow rate.

In the present embodiment there are also provided a pressure sensor 46 that measures a pressure on the upstream side of the fluid resistance element 41, and a temperature sensor 47 that measures a temperature of the fluid flowing through the fluid resistance element 41. The flow rate calculation unit 44 corrects the flow rate of the fluid based on the upstream-side pressure measured by the pressure sensor 46 and on the temperature measured by the temperature sensor 47. In other words, by utilizing the upstream-side pressure and the temperature, the flow rate calculation unit 44 is able to correct the density of the fluid. Note that the pressure sensor 46 and the temperature sensor 47 are mounted on the flow path block 2.

### Effects of the Present Embodiment

In this way, according to the fluid control apparatus 100 of the present embodiment, because it is not necessary for two pressure sensors, namely an upstream-side pressure sensor and a downstream-side pressure sensor to be provided, as is the case in the conventional technology, it is possible to lower the cost of the flow rate measurement mechanism 4. Moreover, because a structure is employed in which a fluid flowing from the upstream side of the fluid resistance element 41 hits against the fluid receiving portion 4x and, thereafter, the fluid that has been made to flow sideways flows through the resistance flow paths 41a of the fluid resistance element 41, it is possible to enlarge the surface area that receives pressure from the fluid flowing through the flow path, and to increase an amount of deformation of a diaphragm that is based on a change in the flow rate. As a result, in a case in which the displacement of the respective flexible components 42a and 42b is measured and the flow rate of a fluid is calculated based on this displacement, it is possible to perform a highly accurate flow rate measurement.

### Additional Embodiments

For example, in the above-described embodiment, the pressure sensor 46 and temperature sensor 47 are provided on the upstream side of the fluid resistance element 41, and the gas density is determined from upstream-side pressure obtained by the pressure sensor 46 and the temperature obtained by the temperature sensor 47, and the flow rate is then corrected using this gas density, however, it is also possible to omit the correction of the flow rate using the gas density, or to not utilize the gas density to correct the flow rate.

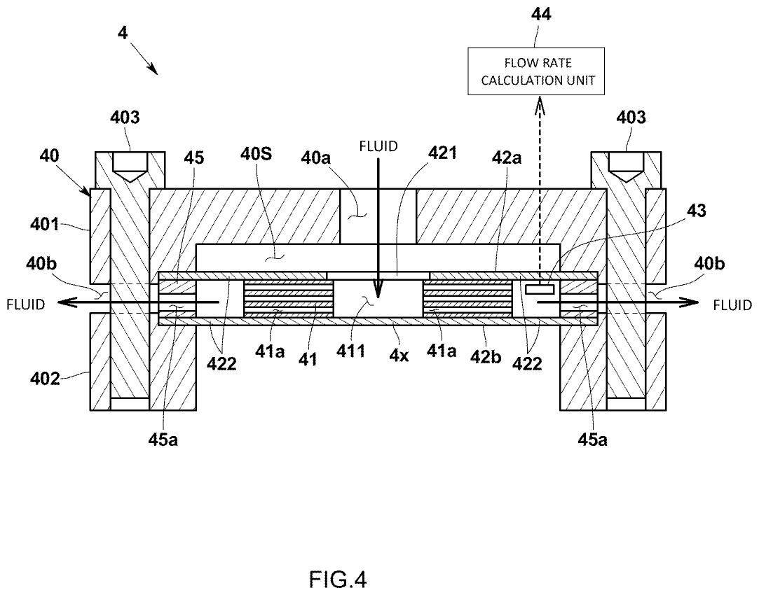

Moreover, as is shown in FIG. 4, it is also possible for the displacement sensor 43 to be disposed on the outer side of the fluid resistance element 41 between the pair of flexible components 42a and 42b. In this case, the location between the pair of flexible components 42a and 42b where the displacement sensor 43 may be provided may be between the fluid resistance element 41 and the spacer component 45. If this structure is employed, then it is possible to reduce the size of the flow rate measurement mechanism 4.

Moreover, in the above-described embodiment a structure is employed in which the fluid resistance element 41, the pair of flexible components 42a and 42b, and the displacement sensor 43 are disposed in the measurement block 40, however, it is also possible to employ a structure in which, instead of using the measurement block 40, they are provided in the flow path block 2.

Furthermore, in the above-described embodiment a structure is employed in which the spacer component 45 is disposed between the pair of flexible components 42a and 42b, however, it is also possible for a spacer portion to be provided integrally with at least one of the pair of flexible components 42a and 42b.

In addition, in the above-described embodiment a structure is employed in which a fluid flows out from between the pair of flexible components 42a and 42b, however, it is also possible to employ a structure in which, for example, an outflow port is formed in the downstream- side flexible component 42b on the outer side of the fluid resistance element 41.

In the above-described embodiment a structure is employed in which the pair of flexible components 42a and 42b are provided, however, it is also possible to employ a structure in which only the upstream-side flexible component 42a is provided.

Moreover, in the above-described embodiment, the fluid receiving portion 4x is formed by the downstream-side flexible component 42b, however, it is also possible to form the fluid receiving portion 4x without utilizing the downstream-side flexible component 42 by blocking off the downstream-side aperture portion of the fluid intake portion 411 of the fluid resistance element 41 using a thin plate or the like.

In addition to the above, it is also possible for the fluid resistance element of the above- described embodiment to be formed by a ceramic restrictor which is a ceramic component in which a multiplicity of through holes have been formed. In this case, supporting the ceramic restrictor by sandwiching it from both sides in the direction of the through holes using a pair of flexible components may be considered.

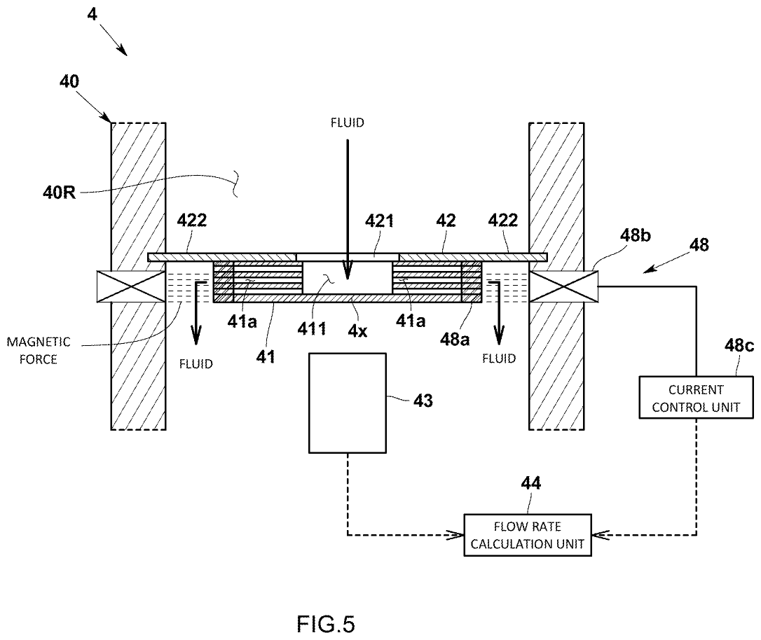

Moreover, as is shown in FIG. 5, it is also possible for the flow rate measurement mechanism 4 to have a structure such as that described below. Note that, in FIG. 5, components that are the same as or that correspond to those in the above-described embodiment are given the same descriptive symbols.

The flow rate measurement mechanism 4 shown in FIG. 5 is provided with the fluid resistance element 41, the fluid receiving portion 4x, a flexible component 42 that supports the fluid resistance element 41 and that deforms in accordance with the flow rate of a fluid, a displacement sensor 43 that measures a displacement of the fluid resistance element 41 or the flexible component 42, a magnetic force adjustment mechanism 48 that adjusts a displacement of the fluid resistance element 41 or the flexible component 42 using magnetic force, and a flow rate calculation unit 44 that calculates the flow rate of the fluid based on the displacement measured by the displacement sensor 43. Here, the fluid resistance element 41 is the same as that of the above-described embodiment, however, it is also possible for the fluid resistance element 41 to be formed by another component such as by a ceramic restrictor which is a ceramic component in which a multiplicity of through holes have been formed, or by an orifice or the like. In addition, this fluid receiving portion 4x is formed by blocking off the downstream-side aperture portion of the fluid intake portion 411 of the fluid resistance element 41 using a thin plate or the like.

The flexible component 42 is provided in a, for example, circular-cylinder shaped measurement block 40 that forms a flow path 40R that communicates with the internal flow path 2R, and is disposed so as to block off this flow path 40R. This flexible component 42 supports the fluid intake portion 411 side of the fluid resistance element 41, and a through hole 421 into which a fluid is able to flow is formed in the fluid resistance element 41. This through hole 421 is formed so as to correspond to the fluid intake portion 411 of the fluid resistance element 41 and communicates with this fluid intake portion 411. Note that, by connecting the flexible component 42 to a peripheral edge portion on the fluid intake portion 411 side of the fluid resistance element 41, it is also possible for the flexible component 42 to be made to support the fluid resistance element 41.

The displacement sensor 43 measures a displacement of the fluid resistance element 41 or the flexible component 42. In the present embodiment, the displacement sensor 43 measures the displacement of the fluid resistance element 41. More specifically, the displacement sensor 43 is disposed on the downstream side of the flow path 40R from the fluid resistance element 41. Sensors that may be used as the displacement sensor 43 include capacitive sensors, oil-filled pressure sensors, position sensors, magnetic sensors, and eddy current sensors and the like.

The magnetic force adjustment mechanism 48 adjusts a displacement of the fluid resistance element 41 or the flexible component 42 using magnetic force. This magnetic force adjustment mechanism 48 includes a magnet 48a that is provided in the fluid resistance element 41 or in the flexible component 42, and an electromagnetic coil 48b that generates magnetic force that acts on the magnet 48a. In the present embodiment, the magnet 48a is provided in the fluid resistance element 41. More specifically, the magnet 48a is disposed in an outer peripheral portion of the fluid resistance element 41. This magnet 48a is formed, for example, in an annular shape that extends in parallel with the exterior configuration of the fluid resistance element 41. Note that it is also possible for a portion of the fluid resistance element 41 to be formed by a magnet.

The electromagnetic coil 48b is provided in the measurement block 40 in such a way as to be positioned to the side of the fluid resistance element 41 (i.e., of the magnet 48a). This electromagnetic coil 48b is an annular object that is provided in the measurement block 40 so as to surround the fluid resistance element 41 (i.e., the magnet 48a). Note that the magnetic force generated in the electromagnetic coil 48b is adjusted as a result of the current flowing through the electromagnetic coil 48b being controlled by a current control unit 48c.

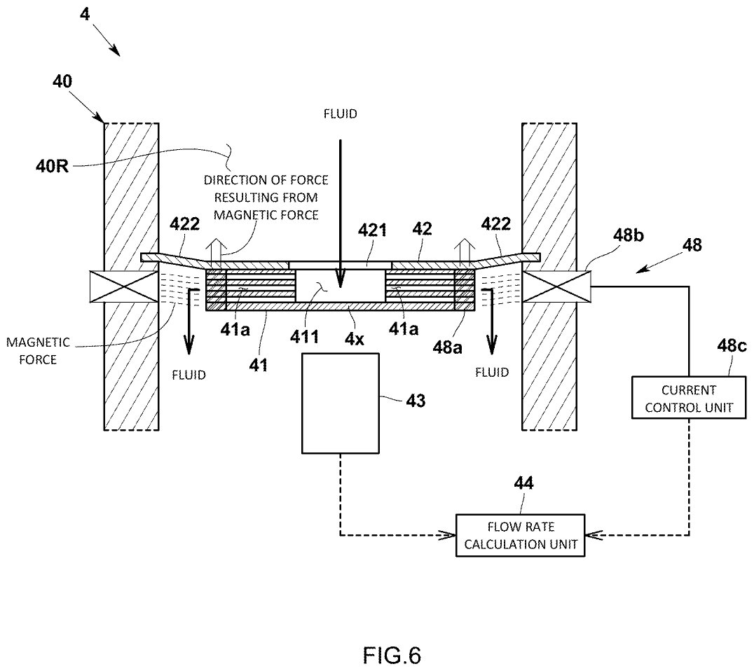

When current is supplied by the current control unit 48c to the electromagnetic coil 48b, then as is shown in FIG. 5 and FIG. 6, magnetic force acts on the magnet 48a. Here, magnetic attraction force acts between the electromagnetic coil 48b and the magnet 48a. As is shown in FIG. 6, if the flexible component 42 receives pressure from a fluid so as to deform towards the downstream side, then due to the magnetic force acting on the magnet 48a, force in the opposite direction from the force received from the fluid acts on the fluid resistance element 41 and the flexible component 42. Note that a structure is employed in which, in a state in which the flexible component 42 does not deform, the aforementioned force in the opposite direction does not act on the fluid resistance element 41 and the flexible component 42 even if there is magnetic force acting on the magnet 48a.

For example, in a case in which a user wishes to widen the flow rate measurement range, the flow rate control unit 48c increases the current supplied to the electromagnetic coil 48b, so as to increase the magnetic force acting on the magnet 48a and make it more difficult for the flexible component 42 to be deformed in accordance with the flow rate. Moreover, in a case in which a user wishes to heighten the flow rate measurement sensitivity, the flow rate control unit 48c reduces or terminates the current supplied to the electromagnetic coil 48b, so as to reduce or terminate the magnetic force acting on the magnet 48a and make it easier for the flexible component 42 to be deformed in accordance with the flow rate.

Moreover, the current control unit 48c is also able to switch between a plurality of set currents that have been set in advance so as to correspond to each one of a plurality of flow rate measurement ranges or flow rate measurement sensitivities. Furthermore, the current control unit 48c is also able adjust the current supplied to the electromagnetic coil 48b based on the amount of displacement measured by the displacement sensor 43. For example, the current control unit 48c is able to increase the current supplied to the electromagnetic coil 48b proportionally as the amount of displacement measured by the displacement sensor 43 increases.

The flow rate calculation unit 44 calculates the flow rate flowing through the internal flow path 2R (i.e., the fluid resistance element 41) based on the displacement measured by the displacement sensor 43 and on the magnetic force employed by the magnetic force adjustment mechanism 48. More specifically, the flow rate calculation unit 44 calculates the flow rate flowing through the internal flow path 2R (i.e., the fluid resistance element 41) based on the displacement measured by the displacement sensor 43 and on the current supplied to the electromagnetic coil 48a. Here, the flow rate calculation unit 44 calculates the flow rate from the displacement measured by the displacement sensor 43 and the current supplied to the electromagnetic coil 48a using relational data that shows a relationship between the displacement measured by the displacement sensor 43, the current supplied to the electromagnetic coil 48a, and the flow rate.

In addition to these, in the same way as in the above-described embodiment, the flow rate calculation unit 44 corrects the flow rate of the fluid based on the upstream-side pressure measured by the pressure sensor 46 and on the temperature measured by the temperature sensor 47. In other words, the flow rate calculation unit 44 performs a density correction on the fluid using the upstream-side pressure and the temperature.

By employing the flow rate measurement mechanism 4 shown in FIG. 5, it is possible to adjust any displacement of the fluid resistance element 41 or flexible component 42 that is generated in accordance with the flow rate of a fluid by using magnetic force. As a consequence, it is possible to dynamically adjust the flow rate measurement range or the flow rate measurement sensitivity.

Furthermore, it should be understood that the present invention is not limited to the above-described embodiments, and that various modifications and the like may be made thereto insofar as they do not depart from the spirit or scope of the present invention.

### DESCRIPTION OF THE REFERENCE CHARACTERS

100 . . . Fluid Control Apparatus
2R . . . Flow Path
41a . . . Resistance Flow Path
4 . . . Flow Rate Measurement Mechanism
41 . . . Fluid Resistance Element
4x . . . Fluid Receiving Portion
411 . . . Fluid Intake Portion
42a . . . Upstream-side Flexible Component
421 . . . Through Hole
42b . . . Downstream-side Flexible Component
43 . . . Displacement Sensor
44 . . . Flow Rate Calculation Unit
45 . . . Spacer Component
45a . . . Outflow Path
46 . . . Pressure Sensor
5 . . . Fluid Control Valve
42 . . . Flexible Component
48 . . . Magnetic Force Adjustment Mechanism
48a . . . Magnet
48b . . . Electromagnetic Coil

What is claimed is:

1. A flow rate measurement mechanism comprising:
a fluid resistance element that is provided on a flow path along which flows a fluid, and in which a resistance flow path is formed;
a fluid receiving portion that is provided on the flow path and is hit by the fluid flowing from an upstream side of the fluid resistance element so as to cause the fluid to flow to a side;
a flexible component that supports the fluid resistance element and deforms in accordance with a flow rate of the fluid;
a displacement sensor that measures a displacement of the flexible component; and
a flow rate calculation unit that calculates a flow rate of the fluid based on the displacement measured by the displacement sensor, wherein
a structure is employed in which the fluid that is made to flow to a side by the fluid receiving portion flows along the resistance flow path of the fluid resistance element.

2. The flow rate measurement mechanism according to claim 1, wherein
the fluid resistance element is formed by a laminated body and the resistance flow path is formed in a direction that intersects the direction of lamination, and
the flexible component supports an upstream-side portion of the fluid resistance element.

3. The flow rate measurement mechanism according to claim 1, wherein,
when viewed from the direction of lamination, a fluid intake portion where a starting end of the resistance flow path opens up is formed in a central portion of the fluid resistance element, and the resistance flow path extends towards an outer peripheral portion from the fluid intake portion, and wherein
the fluid receiving portion is disposed so as to face the fluid intake portion on a downstream side of the central portion of the fluid resistance element.

4. The flow rate measurement mechanism according to claim 1, wherein
the flexible component includes an upstream-side flexible component and a downstream-side flexible component that support the fluid resistance element by sandwiching it from both sides, and
no through holes are formed in the downstream-side flexible component so that the fluid flows out from between the upstream-side flexible component and the downstream-side flexible component.

5. The flow rate measurement mechanism according to claim 4, wherein
through holes that enable the fluid to flow into the fluid resistance element are formed in the upstream-side flexible component, and
fluid that has passed through the fluid resistance element flows out from between the upstream-side flexible component and the downstream-side flexible component.

6. The flow rate measurement mechanism according to claim 4, wherein
the downstream-side flexible component is formed in a flat plate shape, and
the displacement sensor measures displacement of the downstream-side flexible component.

7. The flow rate measurement mechanism according to claim 4, wherein
the displacement sensor is disposed on an outer side of the fluid resistance element between the upstream-side flexible component and the downstream-side flexible component.

8. The flow rate measurement mechanism according to claim 4, further comprising:
an annular spacer component that is disposed so as to surround a periphery of the fluid resistance element between the upstream-side flexible component and the downstream-side flexible component, and
an outflow path through which flows fluid that has passed through the fluid resistance element is formed in the spacer component.

9. The flow rate measurement mechanism according to claim 1, further comprising:
a magnetic force adjustment mechanism that employs magnetic force to adjust the displacement of the flexible component or the fluid resistance element, wherein
the flow rate calculation unit calculates a flow rate of the fluid based on the displacement measured by the displacement sensor and on the magnetic force employed by the magnetic force adjustment mechanism.

10. A flow rate measurement mechanism comprising:
a fluid resistance element that is provided on a flow path along which flows a fluid, and in which a resistance flow path is formed;
a flexible component that supports the fluid resistance element and deforms in accordance with a flow rate of the fluid;
a displacement sensor that measures a displacement of the flexible component or the fluid resistance element;
a magnetic force adjustment mechanism that employs magnetic force to adjust the displacement of the flexible component or the fluid resistance element; and
a flow rate calculation unit that calculates a flow rate of the fluid based on the displacement measured by the displacement sensor.

11. The flow rate measurement mechanism according to claim 10, wherein a magnet on which magnetic force acts is provided in the flexible component or the fluid resistance element, and
the magnetic force adjustment mechanism includes an electromagnetic coil that generates the magnetic force.

12. The flow rate measurement mechanism according to claim 10, wherein the flow rate calculation unit calculates a flow rate of the fluid based on the displacement measured by the displacement sensor and on the magnetic force employed by the magnetic force adjustment mechanism.

13. The flow rate measurement mechanism according to claim 1, further comprising:
a pressure sensor that is disposed on the flow path on the upstream side of the fluid resistance element; and
a temperature sensor that measures a temperature of a fluid flowing through the flow path, wherein
the flow rate calculation unit calculates a flow rate of the fluid based on the displacement measured by the displacement sensor, the pressure measured by the pressure sensor, and the temperature measured by the temperature sensor.

14. A fluid control apparatus comprising:
the flow rate measurement mechanism according to claim 1; and
a fluid control valve that is disposed on the upstream side or the downstream side of the flow rate measurement mechanism.
